(19) United States
(12) Patent Application Publication
(10) Pub. No.: US 2004/0006507 A1
(43) Pub. Date: Jan. 8, 2004

(54) Method for operating a combined hotel/limited time share facility

(75) Inventor: Aharon Laufer, Charlottesville, VA (US)

Correspondence Address: DAVIDSON, DAVIDSON & KAPPEL, LLC, 485 SEVENTH AVENUE, 14TH FLOOR, NEW YORK, NY, 10018, US

(73) Assignee: Laufer IP, LLC, Charlottesville, VA

(21) Appl. No.: 10/612,643

(22) Filed: Jul. 1, 2003

Related U.S. Application Data
(60) Provisional application No. 60/393,552, filed on Jul. 3, 2002.

(51) Int. Cl. G06F 17/60

(52) U.S. Cl. 705/10; 705/5

(57) ABSTRACT

A method for operating a combined hotel/limited timeshare facility in an area having peak demand periods and non-peak demand periods during a year. The method includes operating the hotel/limited timeshare facility as a combined hotel/timeshare facility during the year, and attempting to sell a set of peak period timeshares for intervals corresponding to at least some of the peak demand periods. Yearly sales and marketing expenses related to the sales attempts for the set of peak period timeshares are defined as yearly peak period expenses, and yearly sales and marketing expenses related to sales attempts for non-peak period timeshares of similar duration and quality as the peak period timeshares are less than the yearly peak period expenses.

### CROSS-REFERENCE TO RELATED APPLICATIONS

Priority is claimed to U.S. Provisional Application Serial No. 60/393,552, filed on Jul. 3, 2002, which is incorporated by reference herein.

### BACKGROUND

The present invention relates to a method for operating and financing a combined hotel/limited timeshare facility.

Timesharing of properties, such as vacation properties, has been known for many years. Timesharing involves selling a right to use a particular property for a particular time interval each year (e.g. a specific calendar week), year after year. The timeshare may include a right to use, or may also include an ownership interest in the property. In addition, the timeshare may be limited to a certain number of years, or may extend to the lifetime of the buyer and beyond.

Building and/or purchasing a hotel typically involves substantial initial capital investment. Return on the investment is typically generated through operations of the hotel, and it may take a long time to recover the initial capital investment, thereby increasing the risk and potentially making the investment unattractive to many investors. A timeshare property, on the other hand, generates most of the return on the initial investment from the sale of the timeshares. An investor in the building of a timeshare facility may therefore recoup her initial investment comparatively early in the investment cycle.

A disadvantage of operating a timeshare facility is the high cost associated with generating the timeshare sales. Sales and marketing expenses related to sales attempts for timeshares may easily reach 50% of the revenue generated through such sales. Typically, the less desirable the time period for the area in which the facility is located, the higher the sales and marketing expenses related to selling the timeshare corresponding to that period. In addition, timesharing facilities are subject to a number of state and local regulatory requirements, which may differ widely from region to region. These may include both requirements of the state in which the facility is located as well as requirements of the states in which timeshare sales solicitations are made. Satisfying these requirements can be costly, particularly when the requirements for several states and localities must be satisfied.

It is known to operate a hotel or other multi-unit property as a combined hotel/timeshare facility, in which a certain number of units (e.g. rooms, suites, and/or apartments) are designated to be sold as timeshares, while the rest of the units are operated as regular hotel units. For example, HILTON operates a combined hotel/timeshare in Manhattan that designates the units on two floors for sale as timeshares for intervals during the entire year. Several major hotel chains, such as HILTON, MARRIOTT, and FOUR SEASONS, currently operate combined hotel/limited timeshare facilities. By selling some of the units as timeshares and operating the rest of the facility as a hotel, the owner or operator may recover a portion of the initial investment capital early in the investment cycle while continuing to generate a stream of revenue from the portion of the facility that is operated as a hotel. However, as with ordinary timeshare facilities, the costs associated with selling the timeshares, particularly for the non-peak periods, can be substantial.

ILX Resorts, a publicly traded timeshare/resort company that owns several resorts around the country and Mexico, has a timeshare concept called the Varsity Club. The Varsity Club is a timeshare property in a University town. One such property is in South Bend, Ind., the site of the University of Notre Dame. Although timeshares are offered for the whole year, it is also possible to obtain a timeshare for only the home football game weekends. The timeshares are sold in the form of points in a Vacation Club and those points can be used to stay at any resort the company owns.

### SUMMARY OF THE INVENTION

Timeshares for peak demand time periods during the year are more desirable and therefore typically easier to sell. Typically, the amount of effort involved in selling timeshares for non-peak time periods greatly exceeds the amount of effort involved in selling timeshares for peak time periods. Put another way, the sales and marketing expenses related to sales attempts for non-peak period timeshares typically far outweigh the sales and marketing expenses related to sales attempts for similar peak period timeshares, particularly if those expenses are measured as a percentage of sales revenues of the timeshares.

The present invention provides a method for operating a combined hotel/limited timeshare facility in an area having peak demand periods and non-peak demand periods during a year. The invention includes operating the hotel/limited timeshare facility as a combined hotel/timeshare facility during the year and attempting to sell a set of peak period timeshares for intervals corresponding to at least some of the peak demand periods. Sales and marketing expenses related to the sales attempts for the set of peak period timeshares are defined as peak period expenses. The sales and marketing expenses related to sales attempts for non-peak period timeshares of similar duration and quality as the peak period timeshares are less than the peak period expenses.

The method according to the present invention makes it possible to recover early in the investment cycle a portion of the invested capital for the facility. Moreover, by focusing sales efforts on timeshares for some or all of the peak demand periods, sales and marketing expenses are kept low as compared to such expenses for conventional timeshare facilities. Thus, investors in the combined hotel/limited timeshare facility may recover a portion of their initial investment early in the investment cycle at comparatively little sales expense. That portion may be used, for example, to reduce debt incurred for the building of the facility or reinvested in the same or another facility. In addition, the investors continue to enjoy earnings generated by operations of the facility as a hotel during other less regular peak periods and the non-peak periods. Moreover, because the units are sold as timeshares for only a portion of the year, the cost of complying with state and local regulations pertaining to timeshare properties may also be reduced. In addition, if sales attempts are made only to a well-defined target group, the number of states in which sales attempts are made may be reduced, thereby further reducing the cost of compliance. For example, if sales attempts are made only to the target group during visits to the state in which the facility is located, it may only be necessary to register in that state. Of course, compliance and the cost of compliance is dependent upon the specific regulations.

The peak demand periods preferably are defined as periods during the year when anticipated occupancy rates for the area exceed a certain percentage, and the non-peak demand periods are periods during the year when anticipated occupancy rates are below the certain percentage. The anticipated occupancy rates are preferably determined using historical occupancy rate information for the area or for a competitive set of facilities in the area.

The area for the facility may be a home to a plurality of regularly recurring events during the year, and the intervals for the set of peak period timeshares correspond to the regularly recurring events. The regularly recurring events may include regularly recurring sporting events. A target group of regular attendees of the sporting events is advantageously identified, and the attempting to sell includes attempting to sell only to the target group.

The sporting events may include home games of a team associated with a local institution, such as a local college. The target group may be defined as season ticket holders for the sporting events. Alternatively, the target group may include students of the local institution, alumni of the local institution, and/or season ticket holders for the sporting events.

The intervals may have a short duration, such as one to three days, but may also be longer in duration. In addition, the intervals may be contiguous (e.g. seven consecutive days), or non-contiguous (e.g. six specific weekends). The sales and marketing expenses related to the sales attempts for non-peak period may be zero, such as, for example, when no effort is made to sell non-peak period timeshares.

Attempts to sell the peak period timeshares may begin before the beginning operation of the combined hotel/limited timeshare facility. Sale of timeshares before operation of the facility begins, shortens the time for a portion of the initial investment in the facility to be recovered. Sales may be made of some timeshares before the facility is built or otherwise created so that the proceeds from the sales can be used directly as equity in the facility. Pre-selling timeshares may also reduce the necessary required equity.

The peak period timeshares may include a right to use during the intervals and may be valid for at least three years. The timeshares may also be valid for a longer period and may be valid for the lifetime of the buyer or longer. Each of the peak period timeshares may be associated with a single unit of the facility, or may be associated with more than one unit of the facility.

The present invention also provides a method that includes operating the hotel/limited timeshare facility as a combined hotel/timeshare facility during the year, and attempting to sell a set of peak period timeshares for intervals corresponding to at least some of the peak demand periods, wherein a first ratio of sales and marketing expenses to revenues related to sales attempts for non-peak period timeshares is less than a second ratio of sales and marketing expenses to revenues related to the sales attempts for the set of peak period timeshares.

In addition, the present invention provides a method wherein peak demand periods during the year are when occupancy rates exceed an average occupancy rate of the facility and non-peak demand periods are periods during a year when occupancy rates are below the average occupancy rate. The method includes operating the hotel/limited timeshare facility as a combined hotel/timeshare facility during the year, and attempting to sell a set of peak period timeshares for intervals corresponding to at least some of the peak demand periods, yearly sales and marketing expenses related to the sales attempts for the set of peak period timeshares being defined as yearly peak period expenses. Yearly sales and marketing expenses related to sales attempts for non-peak period timeshares are less than the yearly peak period expenses.

Further, the present invention provides a method that includes operating the hotel/limited timeshare facility as a combined hotel/timeshare facility during the year, and attempting to sell a set of peak period timeshares for intervals corresponding to at least some of the peak demand periods, wherein a first average of the yearly non-peak period expenses per non-peak period timeshare sold is less than a second average of the yearly peak period expenses per peak period timeshare sold.

### BRIEF DESCRIPTION OF THE DRAWINGS

The present invention is explained in more detail below with reference a preferred embodiment of the invention and to the drawings, in which:

FIG. 1 shows a flow chart showing the method according to the present invention; and

FIG. 2 shows a chart representing sample historical occupancy rates for an area.

### DETAILED DESCRIPTION OF A PREFERRED EMBODIMENT

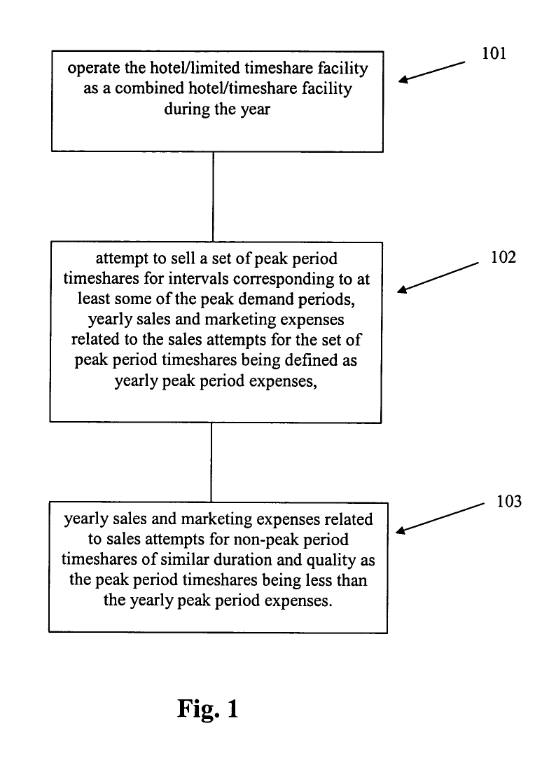

The present invention provides a method for operating a combined hotel/timeshare facility in an area having peak demand periods and non-peak demand periods. As shown in FIG. 1, the hotel/limited timeshare facility is operated as a combined hotel/limited timeshare facility during the year. See block 101. Thus, the facility may be operated during certain periods of the year solely as a timeshare facility and during other periods of the year solely as a hotel facility. Alternatively, the facility may be operated during periods of the year simultaneously as a combined facility, in which some units of the hotel are operated as hotel units and other units within the facility are operated as timeshare units.

In a second step, an attempt is made to sell a set of peak period timeshares for intervals corresponding to at least some of the peak demand periods. Sales and marketing expenses related to the sales attempts for the set of peak period timeshares are defined as peak period expenses. See block 102. The sales and marketing expenses related to sales attempts for non-peak period timeshares of similar duration and quality as the peak period timeshares are less than the peak period expenses. See block 103. By focusing sales efforts on peak period timeshares, those timeshares may be sold quickly with low peak period expenses. Despite such low peak period expenses, sales and marketing expenses related to sales attempts for non-peak period timeshares are nevertheless lower, because comparatively little or no effort is made to sell the non-peak period timeshares. According to the present invention, instead of trying to sell the non-peak period timeshares, the facility is run largely or entirely as a hotel during non-peak demand periods. Non-peak period timeshares may nevertheless be sold, for example, to customers that express interest in purchasing timeshares for non-peak demand periods. However, comparatively little effort, if any, is made to solicit such sales. Thus, sales and marketing expenses related to sales attempts for non-peak period timeshares may be zero, or in any case, lower than the peak period expenses.

Yearly sales and marketing expenses related to sales attempts for non-peak period timeshares are defined as yearly non-peak period expenses. Comparing yearly non-peak period expenses and yearly peak period expenses is a way of evaluating the relative effort directed toward sales of non-peak period timeshares and peak period timeshares. To ensure that apples are being compared with apples, in one embodiment, yearly non-peak-period expenses are compared with yearly peak period expenses by evaluating timeshares of similar duration and quality.

“Duration” refers to the interval length, preferably measured in days, of the timeshare being sold. The intervals may be contiguous (e.g. one seven-day period) or non-contiguous (e.g. six weekends). Also, the interval may include a period of time that recurs less than every year (e.g. the weekend coinciding with the Presidential inauguration in Washington, D.C. every four years). “Quality” is determined according to the physical attributes and amenities of the unit or units being sold as a timeshare without regard to the desirability of the time-period. If the unit is a hotel room, the timeshare for that room will typically have the same quality during the week and on weekends and throughout the year regardless of whether it is sold as a peak period timeshare or a non-peak period timeshare. The quality of two timeshares may be compared, for example, by taking an average of the daily rate for each timeshare unit or units over the course of the year. The average daily rate for a four-room suite will typically be significantly higher than the average daily rate for a single bedroom in the same facility.

If the duration of the non-peak period timeshares differs from duration of the peak period timeshares, a similar duration may be determined by prorating the non-peak period expenses accordingly. Likewise, if the quality of non-peak period timeshares differs from the quality of peak period timeshares, an appropriate adjustment may be made to the non-peak period expenses and or peak period expenses to account for the quality difference. In this way, a sensible comparison can be made between the yearly non-peak period expenses and yearly peak period expenses even when the non-peak period timeshares differ significantly in quality and/or duration from the peak period timeshares

In an alternative embodiment, yearly non-peak period expenses are less than yearly peak period expenses. In a further alternative embodiment, an average of the yearly non-peak period expenses per non-peak period timeshare sold is less than an average of the yearly peak period expenses per peak period timeshare sold. In still a further embodiment, a first ratio of sales and marketing expenses to revenues related to sales attempts for non-peak period timeshares is less than a second ratio of sales and marketing expenses to revenues related to the sales attempts for the set of peak period timeshares.

The steps of the method as shown in FIG. 1 need not occur in the order presented. For example, attempts could be made to sell some or all of the set of peak period timeshares before the facility is opened for business or even before the facility is built or otherwise created. Discounts on the sales price for such timeshares may be offered, for example, to early buyers. Proceeds from early sales of the peak period timeshares would allow a still earlier return on the initial investment, and may, in some cases, even be used to finance the building of the facility.

Preferably, peak demand periods for the area are defined as those periods during the year when anticipated occupancy rates exceed a chosen percentage and non-peak demand periods are periods during the year when anticipated occupancy rates for the facility are below the chosen percentage. Peak demand periods may correspond to recurring events, as is discussed below. Alternatively, the peak and non-peak demand periods can be determined depending upon whether anticipated occupancy rates for a competitive set of hotels or hotels of a similar quality in the area exceed a certain percentage. The chosen percentage may, for example, be a percentage corresponding a high occupancy rate, such as a percentage between 80% and 95%, or to a percentage representing nearly full or full occupancy, such as a percentage greater than 95%. The chosen percentage may also be 100%. Facilities operating at full occupancy often cannot charge rates significantly higher than standard rates, and thus the timeshare price can be used to fully capitalize on the value of the peak period. According to another alternative, the peak demand period may be determined relative to the average occupancy rate for the facility. Peak demand periods may include periods in which the anticipated occupancy rates are greater than an average occupancy rate for the facility by a certain multiple greater than one (e.g. 1.2 times the average occupancy rate).

The area may be the village, town, city, or metropolitan area in which the facility is located, but may also be defined more narrowly as a particular neighborhood, or a location corresponding to a facility (e.g. airport or convention center). The anticipated occupancy rates for the facility are preferably determined using historical data showing occupancy rates in the area, or preferably for a competitive set of hotels in the area in recent years. Such data is typically available through consultants specializing in the hotel industry, and may be made publicly available by the tourism industry itself. For example, such data is available from Smith Travel Research in Hendersonville, Tenn. If a hotel is to be converted using the method of the present invention, actual historical occupancy rates for that hotel may be used. From the historical data, adjustments may be made in determining the anticipated occupancy rates for the facility for the current and future years. Preferably, future macro market events are taken into account in determining anticipated occupancy rates, such as the building of a new airport, stadium, or other facility.

Occupancy rates may be largely driven by events as well as seasonal factors. Where the events are recurring, annually or otherwise, anticipated occupancy rates would correspond to the recurrence of the event, which may or may not correspond to the same calendar dates on which the event occurred in the previous year.

The area for the combined hotel/timeshare facility may be one that is a home to recurring events that historically tend to draw visitors to the area to attend the event or events. The events may recur annually, but also may recur at some other predictable interval, such as biannually or semi-annually. The recurring event may be a holiday, a celebration, a conference, convention or trade fair, a sporting event, a political event, an entertainment event or any other event associated with large gatherings of people. Furthermore, the area is also preferably chosen in which the recurring events are associated with regular attendees that tend to form a welldefined target market. In this way, sales and marketing expenses for selling timeshares may be further reduced by focusing sales efforts on a specific target group of individuals having a high likelihood of regularly attending the recurring events.

In one exemplary embodiment of the invention, the area chosen for the facility is a college town of a college having a popular football team. The facility may be newly built as a combined hotel/limited timeshare facility, or may be created by purchasing an existing hotel or other property and/or by converting a property to the combined hotel/limited timeshare facility.

The college historically draws large crowds to the area for each of the college's home football games. The historical data for the area shows very high occupancy rates for the hotels in the area on the night before and the night after the home football games. Historical occupancy rates are also shown to be high in the area during other college-sponsored sporting events, such as basketball home games. In addition, occupancy rates are also shown to be very high during other regularly recurring college-sponsored events, such as homecoming weekend, graduation, parents weekend, the college spring festival, and an annual summer seminar.

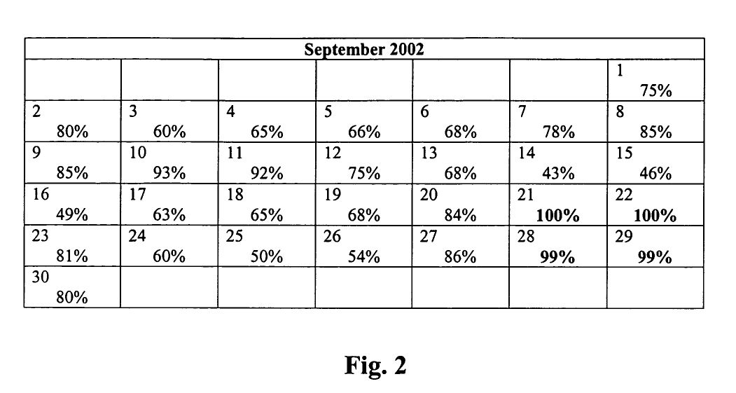

FIG. 2 shows an example of historical hotel occupancy rates for the college town. For simplicity of illustration, the rates are shown only for the single month of September 2002. As shown in FIG. 2, the data shows 100% occupancy in the college town for the nights of 21^{st} and 22^{nd} September and 99% occupancy for the nights of 28^{th} and 29^{th} of September. Those dates correspond to the night before and the night of two Saturday home football games for the college. The period from the 8^{th} to the 12^{th} of September also show relatively high occupancy rates and correspond to the start of the school year when many parents accompany beginning students to the college. The occupancy rates for the entire year 2002 for the college town, not shown in FIG. 2, exceed 95%, for the periods corresponding to each of the college's 6 home football games. In addition, occupancy rates exceeded 95% for a four-day period preceding and including graduation day. The periods corresponding to the college's 16 home basketball games also resulted in very high occupancy rates in the college town, but did not exceed 95%. Several periods corresponding to other college-sponsored events also reflected very high occupancy rates that did not exceed 95%.

Based on the historical data, peak demand periods for the facility may be determined to be each of the two-day periods corresponding to each of the six home football games, and the four-day period corresponding to graduation day. The non-peak periods may be determined to include all the remaining periods during the year for which the occupancy rates in the college town were below 95%. A determination then may be made to attempt to sell a set of peak period timeshares for two-day intervals corresponding to the peak-demand periods corresponding to each of the six home football games, but not attempting to sell timeshares for the intervals corresponding to graduation day. Although graduation day draws large crowds to the area, the makeup of the attendees tends to fluctuate greatly year after year, whereas a comparatively large percentage of the home football games are loyal fans that tend to regularly attend the games.

The actual dates for all future home football games would typically not be known at the time of the sale. However, the football schedule is generally published approximately one year in advance. The contract for the sale of the peak period timeshares may specify that the exact dates of the timeshare intervals would be determined according to the official schedule at the time it is published. The intervals may be defined, for example, to include the night before the game and the night of the game. Similarly, the sales contract may account for future contingencies as later expansion of the season to more than six games or contraction of the season to less than six games, home playoff games, etc.

In any combined hotel/timeshare facility, once timeshares are sold, some revenue will be lost from hotel operations since there are fewer room nights available for sale. However, by pre-selling the high occupancy periods as timeshares, the lost revenue is more than compensated by the revenue from sales of the timeshares. In addition, annual ownership association fees would typically be collected from the timeshare owners, which will also offset the loss of revenue.

Choosing to sell timeshares corresponding to the home football games of the local college team provides several benefits that may keep the sales costs for those timeshares low. Sales efforts may, at least initially, be directed toward season ticket holders for the football games, such as by mail. An alliance may be established between the facility owner and the home college. Through the alliance, the facility owner may gain access to the season ticket holders and perhaps help from the college to sell the timeshare units. In return, the college may receive a percentage of the timeshare proceeds and/or the opportunity to solicit bequests from prospective timeshare buyers or timeshare owners, which, because of the nonprofit nature of the college, may include tax benefits to the timeshare owner.

By limiting sales efforts to a targeted group like season ticket owners, the hotel/timeshare facility may limit the number of states in which it must register to sell timeshares, thereby providing considerable savings in the cost of compliance with state timeshare regulations. For example, the facility may be registered only in the states in which the season ticket owners live. Alternatively, the facility may be registered only in the state in which the facility is located, for example, if solicitations would only be made to members of the target group when they are visiting the state. Sales efforts may also be directed toward students or alumni of the college.

Timeshares may also be sold to students, alumni or regular football game attendees of opposing schools that regularly play the home college town. For example, if the opposing school plays against the college every year, alternating home and away, timeshares could be sold to the opposing school for intervals corresponding to each game that the opposing school plays in the college town (e.g. one two-day interval, every two years).

The exemplary embodiment discussed above does not limit the present invention, but rather, provides a detailed illustration of an example of operating a facility according to the present invention. The inventive concepts also apply to a combined hotel/limited timeshare facility in any area having identifiable peak and non-peak demand periods. The peak demand periods may correspond to recurring events including holidays, conventions, trade fairs, other sporting events, or any other events associated with large gatherings of people.

Timeshares may be sold via any number of transfer devices, including: (a) title to an asset (a deed); (b) a lease for a certain period of time; (c) points in a vacation club, so that with a certain quantity points one can make reservations to units at various times; (d) equity in the facility owning entity. Transfer devices c and d advantageously may permit financing by conventional loans.

With transfer of equity in the facility owning entity, one equity group may own the right to use the asset during certain times and the other receives all the income from the remaining times unused by the first group. Thus, a developer may sell equity in timeshare units to one or a plurality of investors/users and sell the hotel rights to another investor.

Timeshare sales as used herein may also occur within a wider context, for example by selling timeshares or equity in an entire chain of hotels.

Sales and marketing expenses related to the sales attempts for the set of peak period timeshares can be defined as costs associated with the selling of a specific timeshare. As one hypothetical example, the facility employs one timeshare sales person at a salary of $30,000/year and pays a marketing firm $50,000/year to print brochures and place advertisements related to the timeshares in magazines. The sales person has telephone and other office overhead expenses of $20,000. In a preferred embodiment, the sales person is devoting all of his or her time to selling peak period timeshares, for example timeshares for the week of New Years in a combined hotel/timeshare facility in Florida for 100 units of similar quality. The first two weeks of July are also reserved as a non-peak timeshare period for exactly the same 100 units, but this period is not actively sold or marketed. The rest of the time the facility operates as a hotel. The marketing firm produces advertising and brochures solely indicating that the January timeshares are for sale. However, the sales person ends up spending 20% of his or her time fielding calls related to the July timeshares, and 20% of the telephone and office expenses are allocated to the July timeshares. Thus, yearly sales and marketing expenses for all 100 units for the peak January week would be $50,000 of marketing expenses and $50,000*0.8 or $40,000 of sales expenses, for a total of $90,000, or $900 yearly expenses per unit per week to be sold. The yearly sales and marketing expenses for the two week July period then zero marketing expenses and $50,000*0.2 sales expenses, or $10,000. Thus, yearly non-peak period expenses are $50 per unit per week to be sold, which is significantly less than the peak period expenses.

Yearly as defined herein may be calendar or financial year based.

The hotel/timeshare facility may be land-based or may be sea or air-based as well. “Hotel” as defined herein thus may include a cruise-ship or airline selling cabins or seats for specific cruises or flights.

The timeshare interval need not be contiguous in time.

What is claimed is:

1. A method for operating a combined hotel/limited timeshare facility in an area having peak demand periods and non-peak demand periods, comprising the steps of:
operating the hotel/limited timeshare facility as a combined hotel/timeshare facility; and
attempting to sell a set of peak period timeshares for intervals corresponding to at least some of the peak demand periods, yearly sales and marketing expenses related to the sales attempts for the set of peak period timeshares being defined as yearly peak period expenses,
yearly sales and marketing expenses related to sales attempts for non-peak period timeshares of similar duration and quality as the peak period timeshares being less than the yearly peak period expenses.

2. The method as recited in claim 1, wherein the peak demand periods are periods when anticipated occupancy rates exceed a certain percentage, and the non-peak demand periods are periods when anticipated occupancy rates are below the certain percentage.

3. The method as recited in claim 2 wherein the certain percentage is a percentage between 80% and 90%.

4. The method as recited in claim 2 wherein the certain percentage is a percentage between 90% and 95%.

5. The method as recited in claim 2 wherein the certain percentage is a percentage greater than 95%.

6. The method as recited in claim 2, wherein the certain percentage is a current year average occupancy rate for the facility times a certain multiple greater than one.

7. The method as recited in claim 2 wherein the anticipated occupancy rates are determined using historical occupancy rate information for a competitive set of facilities in the area.

8. The method as recited in claim 1 wherein the area is a home to a plurality of regularly recurring events and wherein the intervals for the set of peak period timeshares correspond to the regularly recurring events.

9. The method as recited in claim 8 wherein the plurality of regularly recurring events includes a plurality of regularly recurring sporting events.

10. The method as recited in claim 9 further comprising identifying a target group of regular attendees of the sporting events and wherein the attempting to sell includes attempting to sell only to the target group.

11. The method as recited in claim 9 wherein the sporting events are home games of a team associated with a local institution.

12. The method as recited in claim 10 wherein the target group is defined as season ticket holders for the sporting events.

13. The method as recited in claim 11 wherein the target group includes at least one of students of the local institution, alumni of the local institution, and season ticket holders for the sporting events.

14. The method as recited in claim 1 wherein the intervals have a duration of not greater than three days.

15. The method as recited in claim 1 wherein the set of peak period timeshares include peak period timeshares for non-contiguous intervals.

16. The method as recited in claim 1 wherein the sales and marketing expenses related to the sales attempts for non-peak period timeshares are zero.

17. The method as recited in claim 1 wherein the attempting to sell begins before the operating begins.

18. The method as recited in claim 1 wherein the peak period timeshares are valid for between three years and ten years.

19. The method as recited in claim 1 wherein the peak period timeshares are valid for between three years and perpetuity.

20. The method as recited in claim 1 wherein each of the peak period timeshares is associated with a single unit of the facility.

21. The method as recited in claim 20 wherein the single unit is one of a hotel room, a hotel suite, a building, an airplane seat, and a cabin on a ship.

22. The method as recited in claim 1 wherein the peak period timeshares are attempted to be sold as at least one of lease, a deed, equity in an entity owning the facility, and points to a vacation club.

23. The method as recited in claim 1 wherein the facility is one of an airplane, a ship, a building and a group of buildings.

24. A method for operating a combined hotel/limited timeshare facility in an area having peak demand periods and non-peak demand periods during a year, comprising the steps of:
operating the hotel/limited timeshare facility as a combined hotel/timeshare facility during the year; and
attempting to sell a set of peak period timeshares for intervals corresponding to at least some of the peak demand periods,
wherein a first ratio of sales and marketing expenses to revenues related to sales attempts for non-peak period timeshares is less than a second ratio of sales and marketing expenses to revenues related to the sales attempts for the set of peak period timeshares.

25. A method for operating a combined hotel/limited timeshare facility in an area having peak demand periods during the year when occupancy rates are greater than a certain percentage and non-peak demand periods during a year when occupancy rates are below the certain percentage, the certain percentage being greater than an average occupancy rate of the facility during the year, comprising the steps of:
operating the hotel/limited timeshare facility as a combined hotel/timeshare facility during the year; and
attempting to sell a set of peak period timeshares for intervals corresponding to at least some of the peak demand periods, yearly sales and marketing expenses related to the sales attempts for the set of peak period timeshares being defined as yearly peak period expenses,
yearly sales and marketing expenses related to sales attempts for non-peak period timeshares being less than the yearly peak period expenses.

26. A method for operating a combined hotel/limited timeshare facility in an area having peak demand periods during the year when occupancy rates are greater than a certain percentage and non-peak demand periods during a year when occupancy rates are below the certain percentage, the certain percentage being greater than an average occupancy rate of the facility during the year, comprising the steps of:
operating the hotel/limited timeshare facility as a combined hotel/timeshare facility during the year; and
attempting to sell a set of peak period timeshares for intervals corresponding to at least some of the peak demand periods, yearly sales and marketing expenses related to the sales attempts for the set of peak period timeshares being defined as yearly peak period expenses,
yearly sales and marketing expenses related to sales attempts for non-peak period timeshares being defined as yearly non-peak period expenses,
wherein a first average of the yearly non-peak period expenses per non-peak period timeshare sold is less than a second average of the yearly peak period expenses per peak period timeshare sold.
